(19) United States
(12) Patent Application Publication
(10) Pub. No.: US 2020/0236028 A1
(43) Pub. Date: Jul. 23, 2020

(54) CONCEPT FOR MONITORING NETWORK TRAFFIC COMING INTO A SIGNAL BOX

(71) Applicant: SIEMENS MOBILITY GMBH, MUENCHEN (DE)

(72) Inventors: FRANK AUST, SALZGITTER (DE); MATTHIAS SEIFERT, BUCHHOLZ (DE)

(21) Appl. No.: 16/650,446

(22) PCT Filed: Sep. 6, 2018
(86) PCT No.: PCT/EP2018/073989

§ 371 Date: Mar. 25, 2020

(30) Foreign Application Priority Data
Sep. 29, 2017 (DE) 10 2017 217 422

(51) Int. Cl. H04L 12/26; B61L 27/00; B61L 19/06

(52) U.S. Cl. CPC H04L 43/12; H04L 43/062; B61L 19/06; H04L 43/04; B61L 27/0038; H04L 43/0876

(57) ABSTRACT

A device for monitoring network traffic arriving at a signal box of a railway operating system over a communication network includes a network TAP for reading the network traffic arriving at the signal box over the communication network and outputting the read arriving network traffic to a processor in order to check the read arriving network traffic. A network separating device separates the signal box from the communication network. The processor is configured to actuate the network separating device on the basis of the result of the check of the read arriving network traffic in such a way that the network separating device separates the signal box from the communication network. A corresponding method and a computer program product are also provided.

The invention relates to an apparatus and a method for monitoring a network traffic arriving at a signal box of a railway operating system via a communication network. The invention also relates to a computer program.

In a control center of a railway operating system, typically computer workstations are used for setting routes and for monitoring a railway traffic.

Operating actions which are undertaken, for example, by means of the computer workstations and which affect, for example, a status of a railway track stretch, are typically monitored by a signal box of the railway operating system that assumes the responsibility for safety, before a change to signals, routes or movement releases takes place.

Since typically the computer workstations and the signal box are at different locations, they are usually connected to one another via a communication network.

This means therefore that the signal box is reachable, for example, via a communication network.

There is thus a need to protect the signal box against network traffic arriving via the communication network that could endanger a safety of an operation of the railway operating system.

The object underlying the invention can therefore be seen in providing an efficient concept for the efficient monitoring of a network traffic arriving at a signal box of a railway operating system via a communication network.

This object is achieved by means of the respective subject matter of the independent claims. Advantageous embodiments of the invention are the subject matter of dependent subclaims in each case.

According to one aspect, an apparatus for monitoring a network traffic arriving at a signal box of a railway operating system via a communication network is provided, comprising:

a network TAP for reading the network traffic arriving at the signal box via the communication network and for outputting the read arriving network traffic to a processor for checking the read arriving network traffic,

a network separating device for separating the signal box from the communication network,

wherein the processor is configured, on the basis of a result of the checking of the read arriving network traffic to control the network separating device such that the network separating device separates the signal box from the communication network.

According to another aspect, a method for monitoring a network traffic arriving at a signal box of a railway operating system via a communication network is provided, comprising the following steps:

reading the network traffic arriving at the signal box via the communication network,

checking the read arriving network traffic,

separating the signal box from the communication network on the basis of a result of the checking of the read arriving network traffic.

According to a further aspect, a computer program is provided which comprises program code for carrying out the method for monitoring a network traffic arriving at a signal box of a railway operating system via a communication network when the computer program is executed on a computer, for example, on the apparatus for monitoring a network traffic arriving at a signal box of a railway operating system via a communication network.

The invention is based upon the discovery that the aforementioned object is achieved in that a network TAP also reads the arriving network traffic and outputs it to a processor for the purpose of checking the arriving network traffic. Dependent upon a result of the checking, the signal box is then separated from the communication network, or not.

The use of the network TAP offers, in particular, the technical advantage that it is invisible in the communication network and thus cannot be recognized and attacked by any attacker.

Furthermore, the use of a network TAP has the technical advantage that a reading and thus a corresponding checking of the arriving network traffic can be carried out almost in real time without significant temporal delay, as compared with a so-called “application level gateway (ALG)”. Such an application level gateway can also check a network traffic, but thereby always generates a significant temporal offset and usually changes an originally intended temporal behavior. The time advantage depends, for example, on the scope of the checking that is carried out. This can easily be in the region of several milliseconds up to 500 ms, which would not be tolerable under a requirement for delay-free transmission. In an ALG, data must be copied back and forth several times and channeled through the processor, which itself results in time losses. In addition, there is the actual “processing time”, that is the time for processing by the processor. ALGs are therefore not particularly advantageous.

In that the signal box is separated from the communication network, the technical advantage is achieved, in a particular, that the signal box can then no longer be reached via the communication network. Thus, attackers can no longer attack the signal box via the communication network. The signal box is therefore advantageously efficiently protected against attacks via the communication network.

Furthermore therefore, in particular, the technical advantage is achieved that the network traffic arriving at a signal box of a railway operating system via a communication network can be monitored efficiently.

A network TAP within the sense of the description represents a passive access point to a network connection by which the data signals transmitted over the network connection (that is, for example, the arriving network traffic) can be read for analysis purposes and evaluated. The abbreviation TAP in network TAP stands for Test Access Port.

A network TAP in the sense of the description functions on the OSI-layer 1 and has no MAC address. The network TAP is therefore invisible in the communication network.

In this sense, the network TAP can also be designated a passive network TAP in that it creates the above described passive access point.

The network TAP can, for example, also be designated an Ethernet-TAP.

According to one embodiment, it is provided that the processor is configured for checking the read arriving network traffic, to check a command stream included by the read arriving network traffic for disallowed commands and, on recognition of a disallowed command, to control the a network separating device such that the network separating device separates the signal box from the communication network.

Thereby, in particular, the technical advantage is achieved that disallowed commands can be recognized efficiently. In particular, the technical advantage is thereby achieved that an efficient protection of the signal box against disallowed commands can be brought about.

In another embodiment, it is provided that the processor is configured for checking the command stream to compare commands of the command stream with reference commands of a negative command list, in order to recognize disallowed commands.

Thereby, for example, the technical advantage is achieved that the disallowed commands can be recognized efficiently. The negative command list thus forms a so-called “black list”. Commands which are included by the negative command list are therefore disallowed commands.

Through adaptation of the negative command list, it is therefore made possible in an advantageous manner to react flexibly to different threat scenarios.

According to another embodiment, a protocol device is provided for protocolling the read network traffic.

By this means, for example, the technical advantage is achieved that at a later time point, it can be shown in an efficient way that, for example, disallowed commands were sent to the signal box or that the disallowed commands were successfully prevented from performing corresponding disallowed operating actions.

This means, therefore in particular, that the protocol a device records, that is stores, the read network traffic.

According to one embodiment, it is provided that the network TAP is configured to output the read arriving network traffic to the protocol device.

According to a further embodiment, it is provided that the processor is configured to output the read arriving network traffic to the protocol device.

In another embodiment, it is provided that the network separating device is configured to separate the signal box physically from the communication network.

Thereby, for example, the technical advantage is achieved that an efficient and secure separation of the signal box from the communication network is achieved.

The physical separation comprises, for example, a physical separation of a communication connection between the network TAP and the signal box.

For example, the physical separation comprises an opening of a switch which is connected in a communication connection between the communication network and the signal box, for example between the network TAP and the signal box.

In another embodiment, a command feed device is provided for feeding a test command into the arriving network traffic in order to test the processor, wherein the processor is configured, on recognition of the test command in the context of the checking of the read arriving network traffic, to carry out no control of the network separating device such that the network separating device separates a the signal box from the communication network.

Thereby, in particular, the technical advantage is achieved that an efficient checking of the processor is made possible. This means in particular, therefore, that a recognition of the test command in the arriving network traffic does not result in a separation of the signal box from the communication network.

In one embodiment, it is provided that the command feed device is configured to feed in the test command at pre-determined time intervals.

Thereby, for example, the technical advantage is achieved that the processor can also be tested efficiently over a relatively long timespan.

Such a pre-determined time interval is selected, for example, dependent upon the requirements of the application. For example, it is provided that the test command is fed in once per second or once per minute or once per hour. For example, the time interval is set by an official checker.

In one embodiment it is provided that the processor is configured, on recognition of the test command in the context of the checking of the read arriving network traffic, to send a success message to the command feed device that the test command has been recognized, wherein the command feed device is configured, in the absence of a success message after feeding in of the test command, to control the network separating device such that the network separating device separates the signal box from the communication network.

By this means, for example, the technical advantage is achieved that an error in the processor that leads to a a non-recognition of the test command has no safety-critical effects on the operation of the signal box. This is because in such a case, that is, when a success message is absent, the signal box will be separated from the communication network.

Since, according to this embodiment, the network separating device is controlled accordingly by means of the command feed device in order to separate the signal box from the communication network, in particular, the technical advantage is achieved that, in the event of an error in the processor, the signal box can still be separated from the communication network.

In one embodiment, it is provided that the apparatus for monitoring a network traffic arriving at a signal box of a railway operating system via a communication network is configured to execute or carry out the method for monitoring a network traffic arriving at a signal box of a railway operating system via a communication network.

In one embodiment, it is provided that the method for monitoring a network traffic arriving at a signal box of a railway operating system via a communication network is executed or carried out by means of the apparatus for monitoring a network traffic arriving at a signal box of a railway operating system via a communication network.

According to a further aspect, a railway operating system is provided which comprises the signal box and the apparatus for monitoring a network traffic arriving at a signal box of a railway operating system via a communication network.

Technical functionalities of the apparatus arise similarly from corresponding technical functionalities of the method a and vice versa.

This therefore means, for example, that apparatus features arise from corresponding method features and vice versa.

According to one embodiment, the method comprises the reading of the network traffic arriving at the signal box via the communication network being carried out by means of the network TAP.

According to one embodiment of the method, it is provided that the read arriving network traffic is output to the processor, for example, by means of the network TAP.

According to one embodiment of the method, it is provided for checking the read arriving network traffic, to check a command stream included by the read arriving network traffic for disallowed commands and, on recognition of a disallowed command, to control the network separating device such that the network separating device separates the signal box from the communication network.

In one embodiment of the method, it is provided for checking the command stream that commands of the command stream are compared with reference commands of a negative command list, in order to recognize disallowed commands.

In one embodiment of the method, a protocolling of the read network traffic is provided.

In another embodiment of the method, it is provided that the signal box is physically separated from the communication network.

In one embodiment of the method, it is provided that the signal box is physically separated from the communication network by means of the network separating device.

According to one embodiment of the method, a feeding of a test command into the arriving network traffic is provided in order to test the processor, wherein, on recognition of the test command by the processor in the context of the checking of the read arriving network traffic, the processor carries out no control of the network separating device such that the network separating device separates the signal box from the communication network.

In one embodiment of the method, it is provided that the processor, on recognizing the test command in the context of the checking of the read arriving network traffic, sends a success message to the command feed device that the test command has been recognized, wherein in the absence of a success message after feeding in of the test command, the command feed device controls the network separating device such that the network separating device separates the signal box from the communication network.

In one embodiment it is provided that the command feed device is configured, in the absence of the success message after feeding in of the test command, after a pre-determined timespan has expired, to control the network separating device such that the network separating device separates the signal box from the communication network.

This therefore means, in particular, that it is provided according to this embodiment that the command feed device waits for the pre-determined timespan to expire after the feeding in of the test command before the network separating device is controlled in such a way that the network separating device separates the signal box from the communication network if the success message is absent.

How long waiting takes place after the absence of the success message depends, for example, on the a implementation, that is, on the exact individual case. If, for example, it can be ascertained that within a specific time interval (the pre-determined timespan), an answer would have to take place under all possible operating conditions, according to one embodiment, it is provided that the network separating device is controlled immediately after the pre-determined time interval has expired such that the network separating device separates the signal box from the communication network if the success message is absent.

According to one embodiment, it is provided that the signal box is connected or is connectable via a VPN router to the communication network.

This therefore means, in particular, that according to one embodiment, a VPN router is provided for a connection of the signal box to the communication network. The signal box is connected, for example, to the VPN router.

In one embodiment, it is provided that the network TAP is connected between the VPN router and the signal box.

In one embodiment, it is provided that a computer of a control center of the railway operating system is connectable or connected via the communication network to the signal box.

This therefore means, for example, that according to one embodiment, a computer of a control center of the railway operating system is provided.

In one embodiment, it is provided that the computer of the control center of railway operating system is connected or can be connected via a further VPN router to the communication network.

This means therefore, in particular, that according to one embodiment, a further VPN router is provided for a connection of the computer of the control center to the communication network. The computer is connected, for example, to the further VPN router.

According to one embodiment, the communication network comprises the Internet.

In one embodiment, the communication network comprises a mobile radio network.

According to one embodiment, the computer of the control center is configured as a workstation, for example, as an operating workstation.

By means of the computer of the control center of the railway operating system, for example, it is or can be specified which state the signals of the railway operating system should have or which state or position a set of points of the railway operating system should have or, by means of the computer, a movement release is issued. The possible messages from a signal box include, inter alia, clear and occupied messages regarding track sections and/or flank protection of sets of points.

In one embodiment, it is provided that the command stream is transmitted in the form of PDI and/or SBI telegrams.

Herein, the abbreviation PDI stands for Process Data Interface.

The abbreviation SBI stands for Standard Operating Interface.

In one embodiment, it is provided that the command stream is a command stream of one of the following network protocols: SSH, SFTP, SMB.

A disallowed command in the sense of the description is, for example, a command release. Such a command release brings about in the signal box a lifting of system states or an overriding of the signal box. This means therefore that with the command “command release”, it is made possible to override the signal box in order, for example, to be able to continue a train operation with restricted safety, where for example, a fault in the signal box has taken place and led to a blocking.

An example for such a command release is the case that although a signal shows “red”, a movement command is issued to the train driver or entry into a track section is cleared although the track section is already shown as being occupied. This movement command corresponds here to the command release. Thus, the safety monitoring is put out of effect.

Causes for the necessity of such a command release are, for example, defective track clear notifications which are specifically commanded by an operator at a workstation by means of a CR (command release) command and is overridden in the signal box.

According to one embodiment, an apparatus for monitoring a network traffic arriving at a signal box of a railway operating system via a communication network comprises the signal box.

In one embodiment, an apparatus for monitoring a network traffic arriving at a signal box of a railway operating system via a communication network does not comprise the signal box.

In one embodiment, it is provided that after the expiry of a further pre-determined timespan, the signal box is again connected to the communication network. In command streams according to PDI, SBI, the further pre-determined timespan is, for example, greater than 1 minute, for example, greater than 2 minutes. Within this further pre-determined timespan, according to one embodiment, a CR (command release) action must be completed since, otherwise, it will be identified as invalid.

This therefore means, for example, that the network separating device is configured to connect the signal box to the communication network again after the expiry of a further pre-determined timespan.

This therefore means, for example, that the processor is configured to control the network separating device after the expiry of a further pre-determined timespan such that it connects the signal box to the communication network again.

According to another embodiment, it is provided that the network separating device is configured to separate the signal box physically from the communication network reversibly.

In one embodiment, it is provided that the network separating device is configured to separate the signal box from the communication network irreversibly.

Thus in order, for example, during an irreversible separation by means of the network separating device, to connect the signal box to the communication network again, for example, the network separating device must be exchanged.

The formulation “or” covers, in particular, the formulation “and/or”.

The above-described properties, features and advantages of this invention and the manner in which they are achieved are made more clearly and distinctly intelligible with the following description of the exemplary embodiments which are described in greater detail making reference to the drawings, wherein:

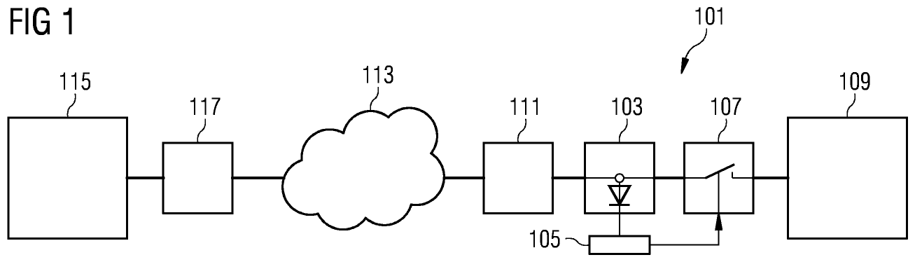

FIG. 1 shows a first apparatus for monitoring a network traffic arriving at a signal box of a railway operating system via a communication network,

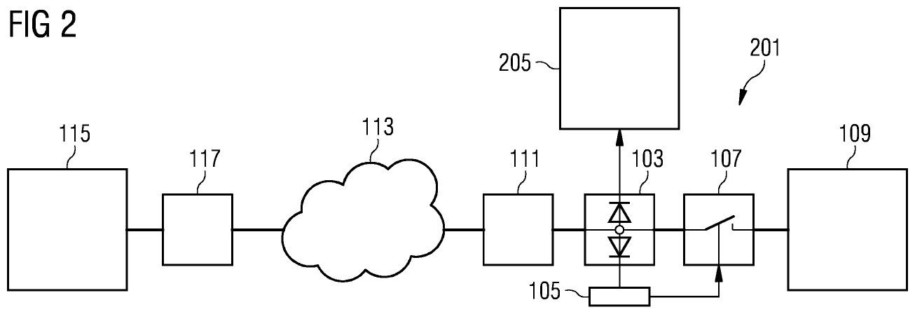

FIG. 2 shows a second apparatus for monitoring a network traffic arriving at a signal box of a railway operating system via a communication network,

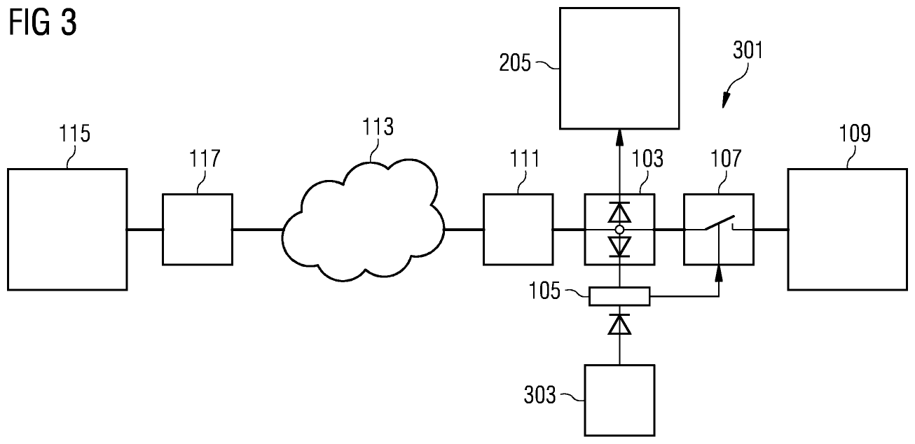

FIG. 3 shows a third apparatus for monitoring a network traffic arriving at a signal box of a railway operating system via a communication network, and

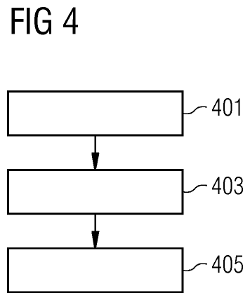

FIG. 4 shows a flow diagram of a method for monitoring a network traffic arriving at a signal box of a railway operating system via a communication network.

In the following, the same reference signs can be used for the same features.

FIG. 1 shows a first apparatus 101 for monitoring a network traffic arriving at a signal box of a railway operating system via a communication network.

The first apparatus 101 comprises:

a network TAP 103 for reading the network traffic arriving at the signal box via the communication network and for outputting the read arriving network traffic to a processor a 105 for checking the read arriving network traffic,

a network separating device 107 for separating the signal box from the communication network,

wherein the processor 105 is configured, on the basis of a result of the checking of the read arriving network traffic to control the network separating device 107 such that the network separating device 107 separates the signal box from the communication network.

FIG. 1 also shows a signal box 109 of a railway operating system (not shown in further detail) which is connected via a VPN router 111 to a communication network 113.

According to one embodiment, the communication network 113 is the Internet.

FIG. 1 further shows an operating workstation 115 of a control center (not shown in detail) of the railway operating system.

The operating workstation 115 is connected to the communication network 113 via a further VPN router 117.

At this point, it should be noted that the further VPN router 117, the Internet as a possible communication network 113 and the VPN router 111 according to one embodiment are not necessarily required. According to one embodiment, the apparatus 101 is installed in the local network of a customer and, for example, must therefore not necessarily be connected to the signal box 109 via the Internet and the VPN router.

The network TAP 103 is connected between the VPN router 111 and the signal box 109.

Furthermore, the network separating device 107 is connected a between the network TAP 103 and the signal box 109.

An exemplary manner of functioning of the first apparatus is described here:

The network TAP 103 reads a command stream which is sent by the VPN router 111 to the signal box 109 and outputs the read command stream to the processor 105. Thus, the network TAP 103 reads the network traffic (command stream) arriving at the signal box 109.

The processor 105 checks the command stream that is transmitted, according to one embodiment, in the form of PDI and/or SBI telegrams, for disallowed commands or disallowed command sequences or disallowed command types, for example, a command release.

If the processor 105 recognizes such a command type or command sequence or a disallowed command, the processor 105 controls the network separating device 107 such that the network separating device 107 separates the network connection between the network TAP 103 and the signal box 109. By this means, the signal box 109 is separated from the communication network 113.

It is typically the case that operating actions that are undertaken using the operating workstation 115 and have an effect on a state of a railway track stretch (not shown) of the railway operating system are monitored by the signal box 109, which assumes the responsibility for safety before a change to signals or routes or movement releases takes place. This typically applies for all commands except for those which are identified with “command release”. Such commands override the signal box 109.

By way of the provision of such “command releases”, it should be possible in the event of a fault, to continue a train operation with limited safety and possibly to lift system conditions in the signal box 109 that have led to a blocking.

By this means, however, safety functions which are installed in the signal box 109 can be circumvented, and this can represent an increased risk in the case of an intentional or unintentional incorrect operation. This applies, above all, if such commands can be initiated via a remote control intentionally or unintentionally.

However, since the remote control, that is for example the connection between the operating workstation 115 and the signal box 109, will be or is configured or designed only for a situation monitoring and, in particular, is not provided for carrying out command release instructions, then command issuings of the type “command release” must be either completely prevented or at least their effect must be suppressed. Care should be taken, in particular, that a monitoring device is not put out of operation.

In the context of new safety legislation, exacting additional protective measures will be required herein but, at the same time, new functionalities required by customers. This situation of two contradictory demands is taken into account with the concept according to the invention.

This is because the command stream which is sent, for example, by the operating workstation 115 via the communication network 113 to the signal box 109 is read by the network TAP 103 and is output to the processor 105 for the purpose of checking. The processor 105 can thus advantageously check this command stream for commands of the type “command release” and on recognition of such a a command, can activate the network separating device 107.

By this means, therefore, in particular, the technical advantage is achieved that by means of a corresponding intended or unintended incorrect operation, no increased endangering takes place, at least a corresponding risk can be reduced.

As a result of the network TAP 103 not being visible in the network, it cannot be attacked and, possibly, be put out of operation.

Thus, the signal box 109 can be reachable via the communication network 113, which is required, for example, by the customer.

At the same time, however, additional protective measures required by the new safety environment are also efficiently implemented.

Thus, according to the invention, two actually contradictory requirements can still be fulfilled.

FIG. 2 shows a second apparatus 201 for monitoring a network traffic arriving at a signal box of a railway operating system via a communication network.

The second apparatus 201 is configured substantially similarly to the first apparatus 101 according to FIG. 1.

In addition to the apparatus 101 according to FIG. 1, the second apparatus 201 comprises a protocol device 205 for protocolling the read network traffic.

The network TAP 103 is thus configured to output the read network traffic to the protocol device 205.

The further elements shown in FIG. 2 and their functional method are identical to the elements shown in FIG. 1, or a their functional methods. For the avoidance of repetition, reference is made to the description above.

By means of the protocol device 205, it is made possible in an advantageous manner to be able to show, even at a later time point, whether the command stream included disallowed commands.

For example, it is provided that the protocol device 205 is configured to protocol a separation of the signal box 109 from the communication network 113.

A protocolling comprises, for example, a storage.

FIG. 3 shows a third apparatus 301 for monitoring a network traffic arriving at a signal box of a railway operating system via a communication network.

The third apparatus 301 is configured substantially similarly to the second apparatus 201 according to FIG. 2.

In addition to the second apparatus 201 shown in FIG. 2, the third apparatus 301 according to FIG. 3 also comprises a command feed device 303 for feeding a test command into the arriving network traffic in order to test the processor 105.

According to this embodiment, the processor 105 is configured, on recognition of the test command in the context of the checking of the read arriving network traffic to carry out no control of the network separating device 107 such that the network separating device 107 separates the signal box 109 from the communication network 113.

In one embodiment it is provided that the third apparatus 301 does not comprise the protocol device 205. According to a this embodiment, the third apparatus 301 is configured substantially similarly to the first apparatus 101 according to FIG. 1. According to this embodiment, in addition to the first apparatus 101 shown in FIG. 1, the third apparatus 301 additionally comprises the command feed device 303.

In one embodiment it is provided that the processor 105 is configured, on recognition of the test command in the context of the checking of the read arriving network traffic, to send a success message to the command feed device 303 that the test command has been recognized, wherein the command feed device 303 is configured, in the absence of a success message after feeding in of the test command, in particular, in the absence of a success message after feeding in of the test command after a pre-determined timespan has expired, for example a maximum of 3 s, to control the network separating device 107 such that the network separating device 107 separates the signal box 109 from the communication network 113.

According to one embodiment, an apparatus for monitoring a network traffic arriving at a signal box of a railway operating system via a communication network comprises the signal box.

In one embodiment, an apparatus for monitoring a network traffic arriving at a signal box of a railway operating system via a communication network does not comprise the signal box.

FIG. 4 shows a flow diagram of a method for monitoring a network traffic arriving at a signal box of a railway operating system via a communication network, comprising the following steps:

reading 401 the network traffic arriving at the signal box a via the communication network,

checking 403 the read arriving network traffic,

separating 405 the signal box from the communication network on the basis of a result of the checking of the read arriving network traffic.

According to one embodiment, it is provided that the method shown and described in relation to FIG. 4 is carried out or executed by means of one of the three apparatuses 101, 201, 301.

This therefore means, for example, that the reading 401 is carried out by means of the network TAP 103.

The network TAP 103 outputs, for example, the read network traffic to the processor 105.

The checking 403 is carried out, for example, by means of the processor 105.

The separation 405 is carried out, for example, by means of the network separating device 107. For this purpose, the processor 105 controls the network separating device 107 accordingly.

In one embodiment, it is provided that after the expiry of a further pre-determined timespan, the signal box 109 is again connected to the communication network 113.

This therefore means, for example, that the network separating device 107 is configured to connect the signal box 109 to the communication network 113 again after the expiry of a pre-determined timespan.

This therefore means, for example, that the processor 105 is configured to connect the signal box 109 to the communication network 113 again after the expiry of a pre-determined timespan.

According to one embodiment, it is provided that the network separating device 107 is configured to separate the signal box 109 from the communication network 113 reversibly.

In one embodiment, it is provided that the network separating device 107 is configured to separate the signal box 109 from the communication network 113 irreversibly.

Although the invention has been illustrated and described in detail based upon the preferred exemplary embodiments, the invention is not restricted by the examples given and other variations can be derived therefrom by a person skilled in the art without departing from the protective scope of the invention.

1-10. (canceled)

11. An apparatus for monitoring network traffic arriving at a signal box of a railway operating system over a communication network, the apparatus comprising:
a network TAP for reading the network traffic arriving at the signal box over the communication network;
a network separating device for separating the signal box from the communication network; and
a processor for receiving the read arriving network traffic from said network TAP and for checking the read arriving network traffic, said processor configured to control said network separating device, based on a result of the checking of the read arriving network traffic, by causing said network separating device to separate the signal box from the communication network.

12. The apparatus according to claim 11, wherein said processor for checking the read arriving network traffic is configured to check a command stream included by the read arriving network traffic for disallowed commands and, upon recognition of a disallowed command, to control said network separating device by causing said network separating device to separate the signal box from the communication network.

13. The apparatus according to claim 12, wherein said processor for checking the command stream is configured to compare commands of the command stream with reference commands of a negative command list, in order to recognize disallowed commands.

14. The apparatus according to claim 11, which further comprises a protocol device for protocolling the read network traffic.

15. The apparatus according to claim 11, wherein said network separating device is configured to separate the signal box physically from the communication network.

16. The apparatus according to claim 11, which further comprises:
a command feed device for feeding a test command into the arriving network traffic in order to test said processor;
said processor being configured, upon recognition of the test command in a context of the checking of the read arriving network traffic, to carry out no control of said network separating device causing said network separating device to separate the signal box from the communication network.

17. The apparatus according to claim 16, wherein:
said processor is configured, upon recognition of the test command in the context of the checking of the read arriving network traffic, to send a success message to said command feed device that the test command has been recognized; and
said command feed device is configured, upon an absence of a success message after feeding-in of the test command, to control said network separating device causing said network separating device to separate the signal box from the communication network.

18. A method for monitoring network traffic arriving at a signal box of a railway operating system over a communication network, the method comprising the following steps:
reading the network traffic arriving at the signal box over the communication network;
checking the read arriving network traffic; and
separating the signal box from the communication network based on a result of the checking of the read arriving network traffic.

19. The method according to claim 18, which further comprises reconnecting the signal box to the communication network after a separation of the signal box from the communication network and after an expiration of a further pre-determined time span.

20. A non-transitory computer program product, comprising program code for carrying out the method according to claim 18 when the computer program is carried out on a computer.
